(19) United States
(12) Patent Application Publication
(10) Pub. No.: US 2005/0071183 A1
(43) Pub. Date: Mar. 31, 2005

(54) Registration management apparatus and registration management program

(75) Inventors: Keisuke Horigami, Kawasaki (JP); Hisashi Inbe, Kawasaki (JP); Hideki Ise, Kawasaki (JP); Yasutaka Tanikawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/786,102

(22) Filed: Feb. 26, 2004

(30) Foreign Application Priority Data
Sep. 29, 2003 (JP) 2003-336736

(51) Int. Cl. G06F 17/60

(52) U.S. Cl. 705/1

(57) ABSTRACT

A registration management apparatus and a registration management program allow minimization of the burden on the user when making user registration. The apparatus includes an information acquisition section that acquires product information concerning a product to be registered, an authorized registration propriety decision section that decides the propriety of authorized registration of the product on the basis of the product information acquired by the information acquisition section, a condition information storage section that stores temporary registration condition information specifying conditions for temporary registration of the product, and a temporary registration section that temporarily registers the product if it is decided to be improper for authorized registration by the authorized registration propriety decision section and the product information concerning the product conforms to the temporary registration conditions.

### BACKGROUND OF THE INVENTION

1. Field of the Invention

The present invention relates to a registration management apparatus and a registration management program for performing registration management concerning products.

2. Description of the Related Art

There are occasions where a user makes initial user registration to a remote center by using E-mail or WEB to receive online support for a product having a unique ID (hereinafter referred to as “product ID”) and transmits client information necessary for the support, e.g. the product ID, to the remote center.

The remote center checks whether or not the product ID transmitted thereto is valid and also checks whether or not the product with the relevant ID has been registered as having been shipped (i.e. whether or not shipping information concerning the relevant product has been registered). Only when the product ID transmitted from the user is judged to be valid (i.e. the product with the relevant ID has been registered in a database as having been shipped), the remote center allows the user registration [for example, see Japanese Patent Application Unexamined Publication (KOKAI) Nos. Hei 10-340253 (p. 3-5, FIG. 2) and 2002-236683 (p. 6-9, FIG. 1).

However, a product ID is assigned to each product manually by an operator. Accordingly, there is likelihood that an incorrect ID may be mistakenly assigned to a product by an operator. Registration of shipping information is also manual processing performed by an operator. Therefore, incorrect information may be registered mistakenly by an operator.

In the event of such a mistake, even if a user transmits a product ID correctly according to the given procedure to make initial user registration, the registered shipping information does not match the ID of the product at the user side. Consequently, the user registration is undesirably rejected by the remote center. In such a case, the user needs to make user registration again after shipping information, etc. has been reregistered to correct the mistake. Accordingly, the completion of user registration is delayed, and the user is burdened unfavorably.

### SUMMARY OF THE INVENTION

The present invention was made in view of the above-described problems with the related art.

Accordingly, an object of the present invention is to provide a registration management apparatus and a registration management program that allow minimization of the burden on the user when making user registration.

The present invention provides a registration management apparatus including an information acquisition section that acquires product information concerning a product to be registered, an authorized registration propriety decision section that decides the propriety of authorized registration of the product on the basis of the product information acquired by the information acquisition section, a condition information storage section that stores temporary registration condition information specifying conditions for temporary registration of the product, and a temporary registration section that temporarily registers the product if it is decided to be improper for authorized registration by the authorized registration propriety decision section and the product information concerning the product conforms to the temporary registration conditions.

With the above-described arrangement, even when authorized registration of a product cannot be made because of a mistake in assigning an ID to the product or a mistake in registration of shipping information, the product is allowed to be temporarily registered if it has product information satisfying predetermined conditions. Consequently, the user is no longer asked to immediately perform formalities necessary for reregistration. Accordingly, the burden on the user can be minimized.

The above-described registration management apparatus preferably further includes a historical information storage section that stores historical information concerning temporary registration processing executed by the temporary registration section, and an information updating section that updates the temporary registration condition information on the basis of the historical information stored in the historical information storage section.

With the above-described arrangement, historical information accumulated as information concerning products that need to be temporarily registered (i.e. products for which there may be mistakes in ID assignment or mistakes in registration of shipping information) can be fed back to the temporary registration conditions. Thus, it is possible to make more accurate temporary registration propriety decision as the registration processing is repeated.

In the above-described registration management apparatus, it is desirable that the temporary registration condition information should include at least ID information concerning products. However, the present invention is not necessarily limited thereto. The temporary registration condition information may include at least information specifying conditions needed to decide the propriety of temporary registration of the product.

If the temporary registration condition information includes ID information concerning products, the propriety of temporary registration can be defined specifically with respect to each individual product. If the temporary registration condition information includes information specifying conditions needed to decide the propriety of temporary registration of the product, it becomes possible to apply arbitrary filtering, for example, filtering of products manufactured on an arbitrary production line or on an arbitrary day. Thus, it becomes possible to flexibly decide the propriety of temporary registration for each particular product.

In the above-described registration management apparatus, the product information may be a product ID.

In addition, the present invention provides a registration management program for instructing a computer to execute registration management concerning products. The program is arranged to instruct a computer to execute an information acquisition step of acquiring product information concerning a product to be registered, an authorized registration propriety decision step of deciding the propriety of authorized registration of the product on the basis of the product information acquired at the information acquisition step, a condition information storage step of storing temporary registration condition information specifying conditions for temporary registration of the product, and a temporary registration step of temporarily registering the product if it is decided to be improper for authorized registration at the authorized registration propriety decision step and the product information concerning the product conforms to the temporary registration conditions.

The above-described registration management program preferably further includes a historical information storage step of storing historical information concerning temporary registration processing executed at the temporary registration step, and an information updating step of updating the temporary registration condition information on the basis of the historical information stored at the historical information storage step.

In addition, the present invention provides a registration management method including an information acquisition step of acquiring product information concerning a product to be registered, an authorized registration propriety decision step of deciding the propriety of authorized registration of the product on the basis of the product information acquired at the information acquisition step, a condition information storage step of storing temporary registration condition information specifying conditions for temporary registration of the product, and a temporary registration step of temporarily registering the product if it is decided to be improper for authorized registration at the authorized registration propriety decision step and the product information concerning the product conforms to the temporary registration conditions.

The above-described registration management method preferably further includes a historical information storage step of storing historical information concerning temporary registration processing executed at the temporary registration step, and an information updating step of updating the temporary registration condition information on the basis of the historical information stored at the historical information storage step.

Thus, the present invention provides a registration management apparatus and a registration management program that allow minimization of the burden on the user when making user registration.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a functional block diagram for explaining a registration management apparatus according to an embodiment of the present invention.

FIG. 2 is a flowchart for explaining the registration management apparatus according to the embodiment of the present invention.

FIG. 3 is a flowchart for explaining the registration management apparatus according to the embodiment of the present invention.

### DETAILED DESCRIPTION OF THE PREFERRED EMBODIMENTS

Embodiments of the present invention will be described below with reference to the accompanying drawings.

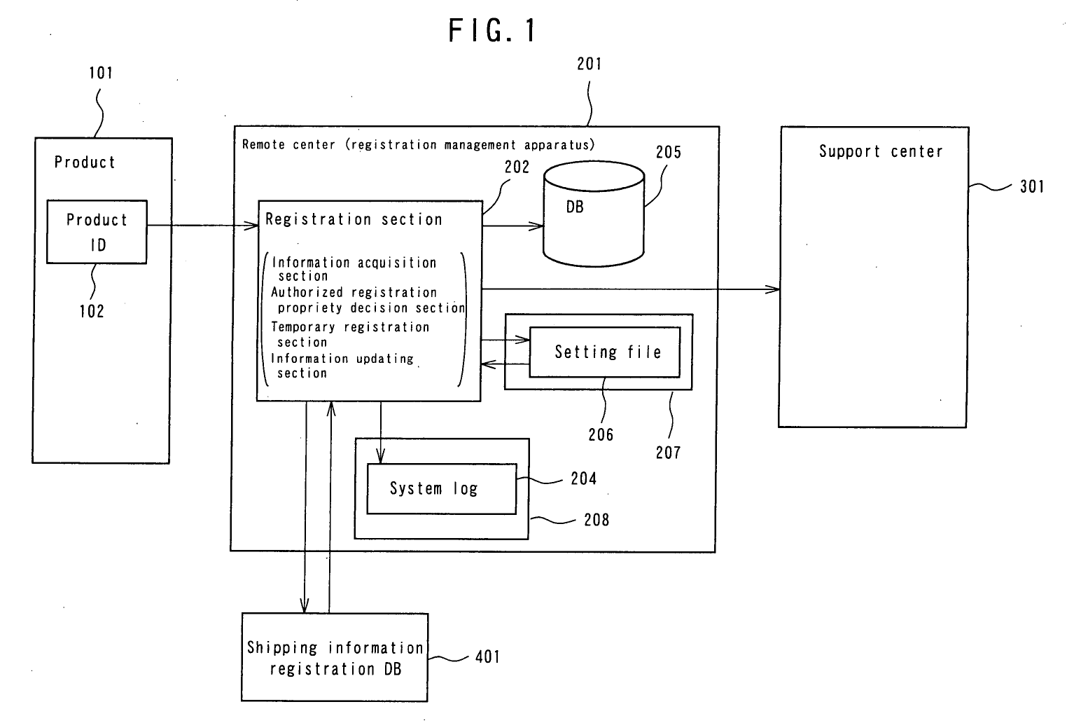

FIG. 1 is a functional block diagram showing an embodiment of the present invention. In FIG. 1, a remote center (registration management apparatus) 201 includes a registration section (serving as an information acquisition section, an authorized registration propriety decision section, a temporary registration section, and an information updating section) 202, a DB (database) 205, a condition information storage section 207 that stores a setting file (temporary registration condition information) 206, and a historical information storage section 208 that stores a system log (historical information) 204.

A product 101 to be registered and a support center 301, together with a shipping information registration DB (database) 401, are communicably connected to the registration management apparatus 201 through communication lines. Thus, a user owning the product 101 can make online user registration through the communication line. Although the registration management apparatus 201 in this embodiment is arranged to accept a user registration request from a single user, it should be noted that the registration management apparatus 201 can handle online user registration requests from a plurality of users simultaneously. Also the product is a personal computer for example, and has a communication function, is able to receive an online support from the remote center.

The product 101 has a unique product ID 102 assigned thereto by an operator at the time of factory shipment.

The support center 301 manages user support concerning products on the basis of information transmitted from the registration management apparatus 201.

The shipping information registration DB 401 is a database in which product IDs, etc. of products shipped from factory have been registered as shipping information. The shipping information registration DB 401 accepts shipping information registration made by an operator when each product is shipped from factory. Although the shipping information registration DB 401 is provided separately from the registration management apparatus 201 in this embodiment, it should be noted that the present invention is not necessarily limited to the illustrated arrangement. The shipping information registration DB 401 may be integral with the registration management apparatus 201.

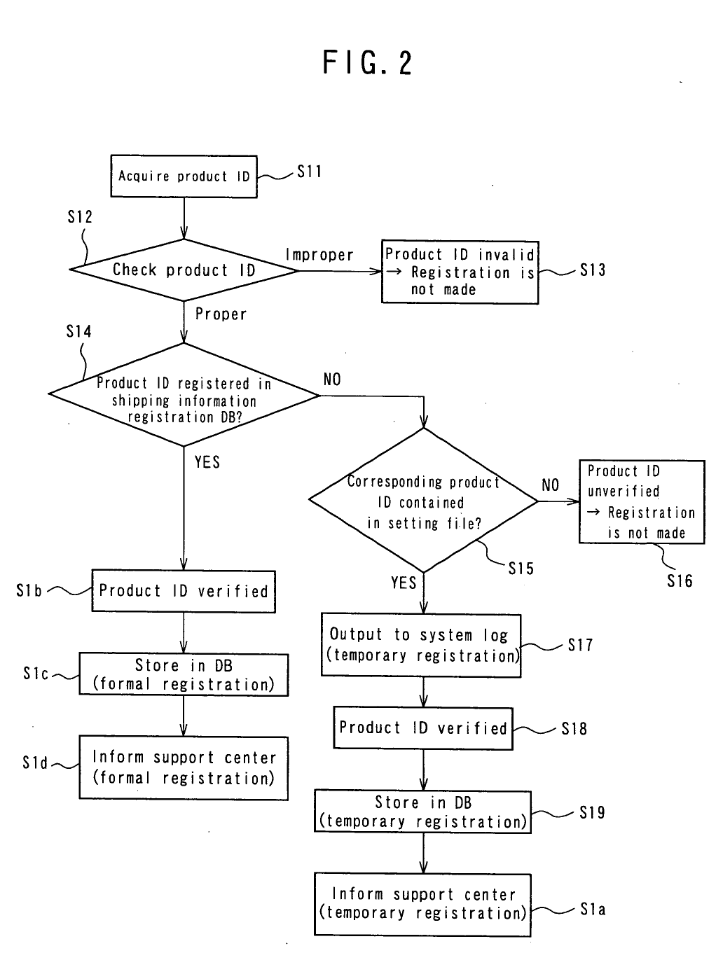

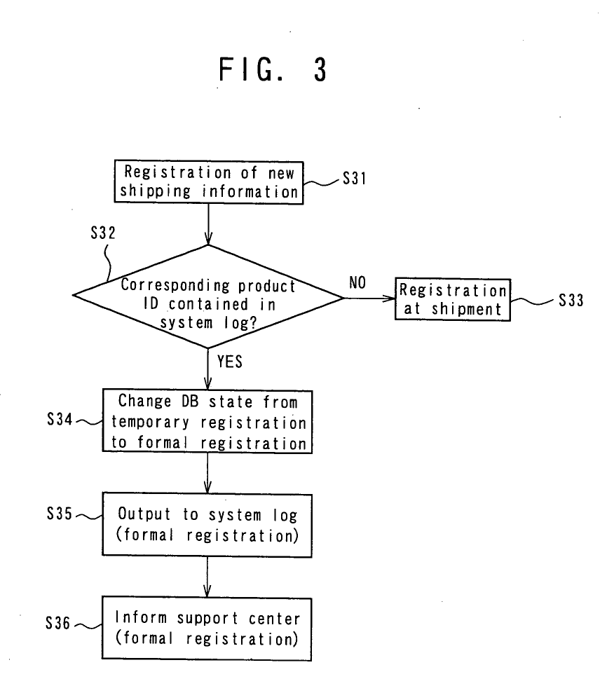

Next, the operation of the registration management apparatus 201 according to the embodiment will be described with reference to flowcharts shown in FIGS. 2 and 3.

First, the registration section 202 acquires a product ID (equivalent to product information) 102 transmitted from the product 101 side (information acquisition step; S11).

Next, the registration section 202 judges whether or not the acquired product ID 102 is valid (step S12). More specifically, the product ID 102 is a piece of information, for example, “model name”, “character string generated from model name and serial number”, or “serial number”. The term “model name” as used herein means the name of the product, for example. The term “serial number” means a piece of information assigned to each product, which consists of a character string that identifies, for example, the date of manufacture, the lot number, etc. The term “character string generated from model name and serial number” means a piece of information obtained by subjecting the above-described “model name” and “serial number” to predetermined computational processing (the processing contents are not open to the user side). Thus, it is possible to judge whether or not an individual is trying to make user registration by adding an unauthorized serial number to a product with a certain model name.

If the acquired product ID is judged to be invalid (if the answer at step S12 is IMPROPER), registration of the relevant product is not executed (step S13).

If the acquired product ID is judged to be valid (if the answer at step S12 is PROPER), the registration section 202 checks whether or not the relevant product ID has been registered in the shipping information registration DB 401 (authorized registration propriety decision step; S14).

If the relevant product ID has, been registered in the shipping information registration DB 401 (if YES at step S14), the product ID is determined to have been verified (step S1b), and the product with the relevant ID is formally registered in the DB 205 (step S1c). It should be noted that in a case where the registration section 202 is arranged to acquire information about where to make contact with the user, etc., together with the product ID 102, this information may be registered in the DB 205, together with the product ID 102.

Thereafter, the registration section 202 informs the support center 301 that the product with the relevant product ID has been formally registered (step S1d).

If the relevant product ID has not yet been registered in the shipping information registration DB 401 (if NO at step S14), it is judged whether or not the relevant product ID conforms to conditions for temporary registration of products that have been prescribed in the setting file (temporary registration conditions) 206 (step S15).

The setting file 206 may contain a list of IDs of products that may be assigned invalid IDs (i.e. products that might have been mistakenly assigned incorrect IDs), for example. Regarding products manufactured on a production line where there was a mistake in ID assignment in the past, there may be a strong possibility of a similar mistake occurring in the ID assignment. In view of this, filtering conditions for selecting products having IDs including a lot number indicating such a production line (i.e. information specifying conditions needed to decide the propriety of temporary registration of each particular product) may be prescribed in the setting file 206. It is also possible to perform filtering by the date of manufacture, etc. (i.e. such filtering conditions may be set in the setting file 206; condition information storage step).

If it is judged that the relevant product ID does not conform to the prescribed conditions (if NO at step S15), it is deemed that there is little possibility of a mistake in ID assignment to the relevant product. Accordingly, the product ID is determined to be unverified, and registration of the relevant product is not made (step S16).

If it is judged that the relevant product ID conforms to the prescribed conditions (if YES at step S15), the registration section 202 outputs a system log entry to the effect that temporary registration will be made for the relevant ID, and adds it to the system log (historical information) 204 stored in the historical information storage section 208 (step S17).

Then, the relevant product ID is determined to have been verified (step S18), and the product with the relevant ID is temporarily registered in the DB 205 (temporary registration step; S19).

Thereafter, the registration section 202 informs the support center 301 that the product with the relevant product ID has been temporarily registered (step S1a).

If temporary registration of the product is made in this way, a predetermined temporary registration period prescribed in the setting file 206 is counted from the day of the temporary registration (it should be noted that the temporary registration period can be set as desired). If the temporary registration period expires without a valid product ID being reregistered to the shipping information registration DB 401 within the temporary registration period, the relevant temporary registration is canceled owing to the expiration of the temporary registration period. The expiration of the temporary registration period is written in the system log 204.

As shown in FIG. 3, if a product ID is registered to the shipping information registration DB 401 within the temporary registration period (step S31), the registration section 202 judges whether or not the relevant product ID matches the product ID of any temporarily registered product, which has been recorded in the system log 204 (step S32).

If the relevant product ID does not match the product ID of any temporarily registered product recorded in the system log 204 (if NO at step S32), the relevant registration is judged to be merely a registration made at the time of factory shipment (i.e. registration of the product ID made at the time of factory shipment of the product; step S33).

If the relevant product ID matches the product ID of a temporarily registered product recorded in the system log 204 (if YES at step S32), the relevant registration is judged to have been made to correct the mistakenly registered product ID for the temporarily registered product, and the registration section 202 changes the temporary registration made in the DB 205 with respect to the relevant product ID to formal registration (step S34).

Then, formal registration information concerning the relevant product ID is added to the system log 204 (step S35). Thereafter, the registration section 202 informs the support center 301 that the product with the relevant product ID has been formally registered (step S36).

As has been stated above, the registration management apparatus according to the embodiment of the present invention includes an information acquisition section that acquires product information concerning a product to be registered, an authorized registration propriety decision section that decides the propriety of authorized registration of the product on the basis of the product information acquired by the information acquisition section, a condition information storage section that stores temporary registration condition information specifying conditions for temporary registration of the product, and a temporary registration section that temporarily registers the product if it is decided to be improper for authorized registration by the authorized registration propriety decision section and the product information concerning the product conforms to the temporary registration conditions.

Regarding products manufactured on a production line where there was a mistake in ID assignment in the past, for example, there may be a strong possibility of a similar mistake occurring in the ID assignment. Therefore, specific product IDs and filtering conditions have been prescribed in the setting file 206 from the beginning with regard to products manufactured on such a production line. In this regard, there may be cases where the incidence of ID assignment mistakes varies with time or the like, depending on the nature of products.

In such cases, the registration section 202 adds information concerning products temporarily registered in the past, which has been recorded in the system log 204, to the present temporary registration conditions prescribed in the setting file 206 (i.e. the registration section 202 serves as an information updating section; the information updating step). By doing so, the accuracy of sorting products that may be mistakenly assigned incorrect IDs according to the temporary registration conditions can be improved with time.

That is, the registration management apparatus according to the embodiment of the present invention preferably further includes a historical information storage section that stores historical information concerning temporary registration processing executed by the temporary registration section, and an information updating section that updates the temporary registration condition information on the basis of the historical information stored in the historical information storage section.

In other words, historical information accumulated as information concerning products that need to be temporarily registered (i.e. products for which there may be mistakes in ID assignment or mistakes in registration of shipping information) can be fed back to the temporary registration conditions.

Thus, it is possible to make more accurate temporary registration propriety decision every time the registration processing is repeated. Meanwhile, a registration management method is composed of the above-described steps, i.e. from the information acquisition step to the temporary registration step, together with or without the historical information storage step and the information updating step. More specifically, the registration management method includes an information acquisition step of acquiring product information concerning a product to be registered, an authorized registration propriety decision step of deciding the propriety of authorized registration of the product on the basis of the product information acquired at the information acquisition step, a condition information storage step of storing temporary registration condition information specifying conditions for temporary registration of the product, and a temporary registration step of temporarily registering the product if it is decided to be improper for authorized registration at the authorized registration propriety decision step and the product information concerning the product conforms to the temporary registration conditions.

The above-described registration management method preferably further includes a historical information storage step of storing historical information concerning temporary registration processing executed at the temporary registration step, and an information updating step of updating the temporary registration condition information on the basis of the historical information stored at the historical information storage step.

The following is a description of a registration management program according to an embodiment of the present invention.

The registration management apparatus 201 according to the embodiment has a CPU (not shown) and a storage section (not shown). The registration management method according to the embodiment is implemented by instructing the CPU (not shown) to execute a registration management program for implementing the above-described steps. The program is stored in the storage section (not shown). As the storage section (not shown), a storage medium such as an HDD, a ROM, a CD-ROM, a DVD, or an FD is usable. The arrangement may be such that the storage section (not shown) is not provided in the registration management apparatus but disposed in an external device connected to the registration management apparatus 201 through a network, and the program is downloaded from the external device to execute it.

More specifically, the registration management program according to the embodiment is intended to instruct a computer to execute registration management concerning products. The program is arranged to instruct a computer to execute an information acquisition step of acquiring product information concerning a product to be registered, an authorized registration propriety decision step of deciding the propriety of authorized registration of the product on the basis of the product information acquired at the information acquisition step, a condition information storage step of storing temporary registration condition information specifying conditions for temporary registration of the product, and a temporary registration step of temporarily registering the product if it is decided to be improper for authorized registration at the authorized registration propriety decision step and the product information concerning the product conforms to the temporary registration conditions.

The above-described registration management program preferably further includes a historical information storage step of storing historical information concerning temporary registration processing executed at the temporary registration step, and an information updating step of updating the temporary registration condition information on the basis of the historical information stored at the historical information storage step.

Although in the foregoing embodiment the registration section serves as the information acquisition section, the authorized registration propriety decision section, the temporary registration section, and the information updating section, the present invention is not necessarily limited to the described arrangement. The registration management apparatus may be provided with a plurality of discrete constituent elements having the respective functions of the above-described sections.

It should be noted that the present invention is not necessarily limited to the foregoing embodiments but can be modified in a variety of ways without departing from the gist of the present invention.

1. A registration management apparatus comprising:
an information acquisition section that acquires product information concerning a product to be registered;
an authorized registration propriety decision section that decides propriety of authorized registration of said product on a basis of the product information acquired by said information acquisition section;
a condition information storage section that stores temporary registration condition information specifying conditions for temporary registration of said product; and
a temporary registration section that temporarily registers said product if it is decided to be improper for authorized registration by said authorized registration propriety decision section and the product information concerning said product conforms to said temporary registration conditions.

2. A registration management apparatus according to claim 1, further comprising:
a historical information storage section that stores historical information concerning temporary registration processing executed by said temporary registration section; and
an information updating section that updates said temporary registration condition information on a basis of said historical information stored in said historical information storage section.

3. A registration management apparatus according to claim 1, wherein said temporary registration condition information includes at least ID information concerning products.

4. A registration management apparatus according to claim 1, wherein said temporary registration condition information includes at least information specifying conditions needed to decide propriety of temporary registration of said product.

5. A registration management apparatus according to claim 1, wherein said product information is a product ID.

6. A registration management program for instructing a computer to execute registration management concerning products, said program comprising:
an information acquisition step of acquiring product information concerning a product to be registered;
an authorized registration propriety decision step of deciding propriety of authorized registration of said product on a basis of the product information acquired at said information acquisition step;
a condition information storage step of storing temporary registration condition information specifying conditions for temporary registration of said product; and
a temporary registration step of temporarily registering said product if it is decided to be improper for authorized registration at said authorized registration propriety decision step and the product information concerning said product conforms to said temporary registration conditions.

7. A registration management program according to claim 6, further comprising:
a historical information storage step of storing historical information concerning temporary registration processing executed at said temporary registration step; and
an information updating step of updating said temporary registration condition information on a basis of said historical information stored at said historical information storage step.

8. A registration management method comprising:
an information acquisition step of acquiring product information concerning a product to be registered;
an authorized registration propriety decision step of deciding propriety of authorized registration of said product on a basis of the product information acquired at said information acquisition step;
a condition information storage step of storing temporary registration condition information specifying conditions for temporary registration of said product; and
a temporary registration step of temporarily registering said product if it is decided to be improper for authorized registration at said authorized registration propriety decision step and the product information concerning said product conforms to said temporary registration conditions.

9. A registration management method according to claim 8, further comprising:
a historical information storage step of storing historical information concerning temporary registration processing executed at said temporary registration step; and
an information updating step of updating said temporary registration condition information on a basis of said historical information stored at said historical information storage step.
